(19) United States
(12) Patent Application Publication
(10) Pub. No.: US 2026/0141395 A1
(43) Pub. Date: May 21, 2026

(54) METHOD AND SYSTEM FOR IMPLEMENTING A RECOMMENDATION PLATFORM FOR FINANCIAL INSTITUTION POLICY ENGINE

(71) Applicant: Panax Tech Ltd., Tel Aviv (IL)

(72) Inventor: Yosef Haim ITZKOVICH, Tel Aviv (IL)

(73) Assignee: Panax Tech Ltd., Tel Aviv (IL)

(21) Appl. No.: 19/395,498

(22) Filed: Nov. 20, 2025

Related U.S. Application Data
(60) Provisional application No. 63/722,871, filed on Nov. 20, 2024.

(51) Int. Cl. G06Q 20/40; G06Q 30/018; G06Q 40/12

(52) U.S. Cl. CPC G06Q 20/4016; G06Q 30/018; G06Q 40/124

(57) ABSTRACT

A system and method of checking compliance and enforcing a financial risk policy of a business, are provided herein. The method may include the following steps: receiving financial data of the business, said financial data comprising distribution of funds of the business; obtaining a financial risk policy relating to distribution of funds of the business; detecting a deviation of distribution of the funds from the policy; and optionally issuing an audit relating to the distribution of the funds of the business in view of the deviation from the policy.

### CROSS REFERENCE TO RELATED APPLICATIONS

This application claims the benefit of U.S. Provisional Patent Application No. 63/722,871, filed Nov. 20, 2024, which is incorporated herein by reference in its entirety.

### FIELD OF THE INVENTION

The present invention relates generally to the field of data processing, and more particularly to automatic classification of financial data.

### BACKGROUND OF THE INVENTION

Financial compliance is a complex data intense process which affects how businesses are managed and the level of risk involved.

One challenge in this field is how to effectively check the compliance of a businesses against a financial policy governing the distribution of funds of the business. Compliance of a business with such a financial policy is important in order to reduce and control risk factors.

Businesses routinely manage large volumes of financial-distribution data generated across accounting platforms, enterprise resource planning systems, payment processors, and internal cost-allocation systems. Ensuring compliance with internal and external financial risk policies requires constant monitoring of this data to identify deviations in the distribution of funds. Conventional verification approaches typically rely on manually drafted rules and human review of transactional summaries. These approaches are often slow, inconsistent, and impractical at scale, particularly where real-time anomaly detection is required.

Existing automated systems often depend on static rule sets that do not adapt to the specific characteristics of a given business. This limits the system's ability to generate relevant risk policies and detect deviations with accuracy. There remains a need for an improved computer-implemented system capable of automatically ingesting financial distribution data, generating policies tailored to a specific business, detecting deviations relative to such policies, and producing audit outputs in a structured, consistent, and scalable manner.

### SUMMARY OF THE INVENTION

In order to address the aforementioned challenges, some embodiments of the present invention improve basic technology and provide an automatic tool for checking compliance of a business against a financial policy.

Some embodiments of the present invention include a system and method of checking compliance and enforcing a financial risk policy of a business. The method may include the following steps: receiving financial data of the business, said financial data comprising distribution of funds of the business; obtaining a financial risk policy relating to distribution of funds of the business; detecting a deviation of distribution of the funds from the policy; and issuing an audit relating to the distribution of the funds of the business in view of the deviation from the policy.

Embodiments of the present invention provide a computer-implemented method executed by a server configured to monitor and evaluate financial distribution data of a business. The server receives financial data associated with the business and obtains a financial risk policy defining permissible distributions of funds. The server analyzes the data against the policy to detect deviations. Upon detection of a deviation, the server generates an audit evaluating compliance with the applicable policies.

In some embodiments, the server generates the policy automatically using a machine learning model trained to produce tailored policies based on the characteristics of the business. The system can produce compliance scores using quantitative metrics such as thresholds and margins of distribution. The resulting audit package can include deviation indicators, compliance scores, and metadata describing the analytic processing performed by the server.

These embodiments provide technological improvement by enabling the server to transform raw financial records into structured compliance intelligence, thereby automating processes that traditionally required expert human oversight and manual analysis.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating a system for automatic compliance check of a business against a financial policy in accordance with embodiments of the present invention; and

FIG. 2 is a flowchart illustrating a method of automatic compliance check of a business against a financial policy in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

In the foregoing detailed description, numerous specific details are set forth in order to provide an understanding of the invention. However, it will be understood by those skilled in the art that the invention can be practiced without these specific details. In other instances, well-known methods, procedures, and components, modules, units, and/or circuits have not been described in detail so as not to obscure the invention. Some features or elements described with respect to one embodiment can be combined with features or elements described with respect to other embodiments.

The present invention, in embodiments thereof, provides a policy engine to allow assessing different risk dimensions and getting an overall risk score.

According to some embodiments of the present invention, some possible dimensions may include: financial institutes (bank) exposure in percentage; geography exposure in percentage; account type Exposure percentage-money market/term deposits/credit lines/checking; and revenue stream from customer that account to more than a specific percentage.

According to some embodiments, a recommendation system is also provided. The recommendation system factors in the appropriate dimensions and suggest applying a specific threshold or range for fund distribution according to the general characteristics and attributes which are unique to the business. Such attributes may include: geography, revenue, number of employees, and the business sector or domain in which the business is operating.

### System Overview

In accordance with embodiments of the present invention, a server is configured to receive financial data from one or more business systems. The data may be obtained through secure API calls, batch uploads, or event-driven data streams. The data typically includes records of fund allocations across accounts, business units, projects, vendors, jurisdictions, or other financial categories.

Upon receiving the data, the server normalizes the records into a structured data format suitable for high-efficiency computation. Examples include a columnar data structure, a graph-based ledger model, or a time-series event log. Normalization enables rapid analysis and facilitates the computation of policy thresholds and distribution patterns.

### Policy Acquisition or Generation

The server obtains a financial risk policy specifying allowable distributions of funds. In some embodiments, the policy is uploaded directly by a customer. In others, the policy is automatically generated by the server using a machine learning model.

The machine learning model may be trained on historical distributions across a population of businesses, along with known outcomes such as compliance results or risk events. Inputs to the model may include business size, revenue, business sector, regulatory jurisdiction, operational complexity, or other attributes influencing appropriate financial distribution practices. Based on these characteristics, the server generates a tailored policy containing quantitative parameters such as allowable allocation percentages, maximum thresholds, or margin limits for specific fund categories.

### Deviation Detection

The server executes a deviation detection module that compares the normalized financial distribution data to the policy constraints. The module evaluates distributions across multiple categories and performs quantitative checks. These can include:
1. threshold comparisons
2. variance and margin calculations
3. time-based deviations or pattern irregularities
4. outlier detection
5. distribution ratio analysis
The detection module identifies any category of fund distribution that falls outside policy parameters and generates a deviation indicator.

### Audit Generation and Scoring

When a deviation is detected, the server initiates an automated audit process. The server generates a compliance score based on the degree of deviation relative to the policy. The scoring engine uses quantitative metrics and may consider multiple policies, such as a set of autogenerated policies or a set of customer-defined policies.
1. The output audit may include:
2. compliance scores
3. deviation markers
4. statistical summaries
5. category-specific analysis
6. generated policies or thresholds used during evaluation
The audit is formatted into a structured package suitable for display, reporting, or integration into downstream audit-management platforms.

### Technical Improvements

The system described herein improves computer functionality by enabling:
1. Automated transformation of unstructured or semi-structured financial data into normalized analytic structures.
2. Dynamic generation of tailored risk policies using machine learning, enhancing relevance and accuracy.
3. High-speed, automated comparison of financial distributions to policy constraints using a specialized deviation-detection engine.
4. Automatic generation of structured audit outputs without reliance on human review.

These technical improvements enable scalable, real-time financial compliance monitoring that is not feasible using conventional manual processes.

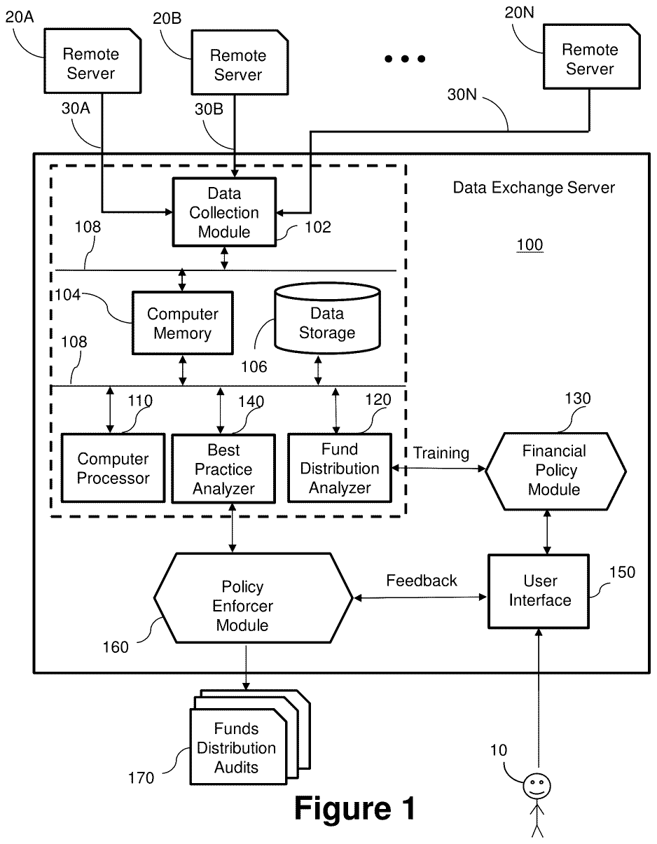

FIG. 1 is a high-level block diagram illustrating a system 100 for an automatic checking of compliance of a business against a financial policy. System 100 may include: a computer processor 110; a bus 108 connecting all modules, and computer memory 104 comprising a set of instructions that, when executed, cause computer processor 110 to: collect via a data collection module 102, financial data 20A-20N obtained from various financial institutions and associated with a business and store them on a data storage 106.

Computer processor 110 may be further configured to obtain, using financial policy module 130 a financial risk policy relating to distribution of funds of the business. Computer processor 110 may be further configured detect, using policy enforcer module 160 a deviation of distribution of the funds from the policy; and issue financial distribution audits 170 relating to the distribution of the funds of the business in view of the deviation from the policy.

According to some embodiments, in system 100, the issuing an audit comprises scoring the compliance of the business against a set of autogenerated policies matching the business's profile.

According to some embodiments, in system 100, the issuing an audit comprises scoring the compliance of the business against a set of policies defined by the customer.

According to some embodiments, in system 100, the scoring comprises quantitative indication in terms of thresholds and margins of distribution of the funds of the business in view of the generated policies matching to the business's profile.

According to some embodiments, in system 100, the autogenerated policies matching to the business's profile comprising generating a policy using machine learning model creating a tailored policy for the specific business.

According to some embodiments, in system 100, the generating of the policy using machine learning model is based on business characteristics and attributes comprising at least one of: size, revenue, business sector, and jurisdiction.

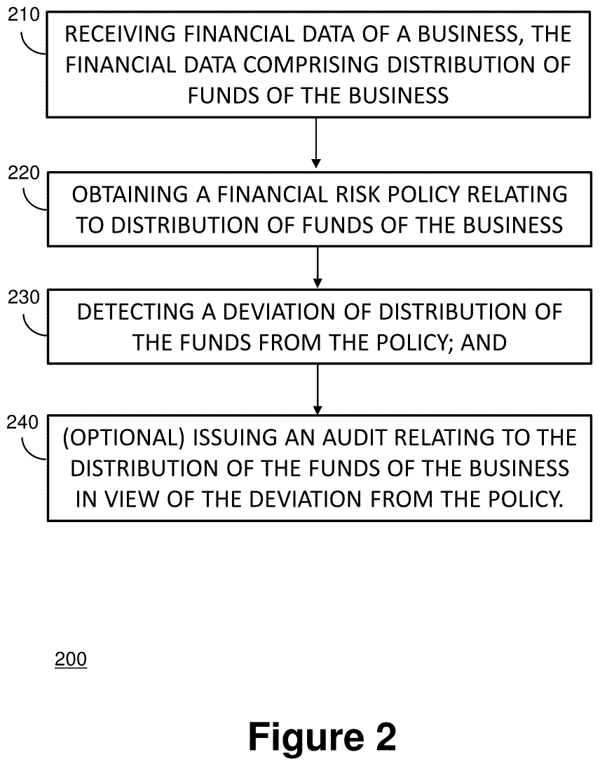

FIG. 2 is a high-level flowchart illustrating a method 200 of automatically checking compliance and enforcing a financial risk policy of a business. The method may include the following steps: receiving financial data of the business, said financial data comprising distribution of funds of the business 210; obtaining a financial risk policy relating to distribution of funds of the business 220; detecting a deviation of distribution of the funds from the policy 230; and issuing an audit relating to the distribution of the funds of the business in view of the deviation from the policy 240.

According to some embodiments, in method 200, the issuing an audit comprises scoring the compliance of the business against a set of autogenerated policies matching the business's profile.

According to some embodiments, in method 200, the issuing an audit comprises scoring the compliance of the business against a set of policies defined by the customer.

According to some embodiments, in method 200, the scoring comprises quantitative indication in terms of thresholds and margins of distribution of the funds of the business in view of the generated policies matching to the business's profile.

According to some embodiments, in method 200, the autogenerated policies matching to the business's profile comprising generating a policy using machine learning model creating a tailored policy for the specific business.

According to some embodiments, in method 200, the generating a policy using machine learning model, based on business characteristics and attributes comprising at least one of: size, revenue, business sector, and jurisdiction.

It is further understood that some embodiments of the present invention may be embodied in the form of a system, a method, or a computer program product. Similarly, some embodiments may be embodied as hardware, software, or a combination of both. Some embodiments may be embodied as a computer program product saved on one or more non-transitory computer-readable medium in the form of computer-readable program code embodied thereon. Such non-transitory computer-readable medium may include instructions that when executed cause a processor to execute method steps in accordance with embodiments. In some embodiments, the instructions stored on the computer-readable medium may be in the form of an installed application and in the form of an installation package.

Such instructions may be, for example, loaded via one or more processors and executed. For example, the computer-readable medium may be a non-transitory computer-readable storage medium. A non-transitory computer-readable storage medium may be, for example, an electronic, optical, magnetic, electromagnetic, infrared, or semiconductor system, apparatus, or device, or any combination thereof.

Computer program code may be written in any suitable programming language. The program code may execute on a single computer system, or on a plurality of computer systems.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units, and/or circuits have not been described in detail so as not to obscure the invention. Some features or elements described with respect to one embodiment can be combined with features or elements described with respect to other embodiments.

1. A method of checking compliance and enforcing a financial risk policy of a business, the method comprising:
receiving financial data of the business, said financial data comprising distribution of funds of the business;
obtaining a financial risk policy relating to distribution of funds of the business; and
detecting a deviation of distribution of the funds from the policy.

2. The method of claim 1, further comprising issuing an audit relating to the distribution of the funds of the business in view of the deviation from the policy.

3. The method of claim 2, wherein the issuing of the audit comprises scoring the compliance of the business against a set of autogenerated policies matching the business's profile.

4. The method of claim 2, wherein issuing an audit comprises scoring the compliance of the business against a set of policies defined by the customer.

5. The method of claim 4, wherein the scoring comprises quantitative indication in terms of thresholds and margins of distribution of the funds of the business in view of the generated policies matching to the business's profile.

6. The method of claim 3, wherein the autogenerated policies matching the business's profile are obtained by generating a policy using machine learning model creating a tailored policy for the specific business.

7. The method of claim 6, wherein the generating of the policy using machine learning model, based on business characteristics and attributes comprising at least one of: size, revenue, business sector, and jurisdiction.

8. A system for checking compliance and enforcing a financial risk policy of a business, the system comprising:
a data collection mode configured to receive financial data of the business, said financial data comprising distribution of funds of the business;
a financial policy module configured to obtain a financial risk policy relating to distribution of funds of the business; and
a policy enforcer module configured to: detect a deviation of distribution of the funds from the policy.

9. The system of claim 8, wherein the policy enforcer module is configured to issue an audit relating to the distribution of the funds of the business in view of the deviation from the policy.

10. The system of claim 9, wherein issuing an audit comprises scoring the compliance of the business against a set of autogenerated policies matching the business's profile.

11. The system of claim 9, wherein issuing an audit comprises scoring the compliance of the business against a set of policies defined by the customer.

12. The system of claim 11, wherein the scoring comprises quantitative indication in terms of thresholds and margins of distribution of the funds of the business in view of the generated policies matching to the business's profile.

13. The system of claim 10, wherein autogenerated policies matching the business's profile are obtained by generating a policy using machine learning model creating a tailored policy for the specific business.

14. The system of claim 13, wherein the generating of the policy using machine learning model, based on business characteristics and attributes comprising at least one of: size, revenue, business sector, and jurisdiction.

15. A non-transitory computer readable medium for checking compliance and enforcing a financial risk policy of a business, comprising a set of instructions that, when executed, cause at least one computer processor to:
receive financial data of the business, said financial data comprising distribution of funds of the business;
obtain a financial risk policy relating to distribution of funds of the business; and
detect a deviation of distribution of the funds from the policy.

16. The non-transitory computer readable medium of claim 15, further comprising a set of instructions that, when executed, cause the at least one computer processor to issue an audit relating to the distribution of the funds of the business in view of the deviation from the policy.

17. The non-transitory computer readable medium of claim 16, wherein issuing an audit comprises scoring the compliance of the business against a set of autogenerated policies matching the business's profile.

18. The non-transitory computer readable medium of claim 16, wherein issuing an audit comprises scoring the compliance of the business against a set of policies defined by the customer.

19. The non-transitory computer readable medium of claim 18, wherein the scoring comprises quantitative indication in terms of thresholds and margins of distribution of the funds of the business in view of the generated policies matching to the business's profile.

20. The non-transitory computer readable medium of claim 17, wherein the autogenerated policies matching the business's profile are obtained by generating a policy using machine learning model creating a tailored policy for the specific business.
